(19) United States
(12) Patent Application Publication
(10) Pub. No.: US 2025/0307337 A1
(43) Pub. Date: Oct. 2, 2025

(54) Information Processing Method, Information Processing Program, and Information Processing System

(71) Applicant: Hitachi, Ltd., Tokyo (JP)

(72) Inventors: Nobuaki OZAKI, Tokyo (JP); Taku WAKUI, Tokyo (JP); Mineyoshi MASUDA, Tokyo (JP)

(21) Appl. No.: 19/028,379

(22) Filed: Jan. 17, 2025

(30) Foreign Application Priority Data
Mar. 29, 2024 (JP) 2024-057824

(51) Int. Cl. G06F 16/958; G06F 40/30

(52) U.S. Cl. CPC G06F 16/958; G06F 40/30

(57) ABSTRACT

An object of the present invention is to acquire relevant information that is acquired from an external database or the like and input to a generative AI, in an appropriate amount of data. An information processing system manages semantic rule information including a semantic rule for acquiring, as linkage information, information in a Web page whose semantic linkage is specified on the basis of grammar of a source code of the Web page, and cyclic rule information including a cyclic rule for defining a cyclic order of a plurality of Web pages at the time of acquisition of relevant information. Then, the plurality of Web pages are circulated on the basis of the cyclic rule, and the linkage information is acquired as the relevant information from each of the circulated Web pages on the basis of the semantic rule.

### BACKGROUND OF THE INVENTION

### 1. Field of the Invention

The present invention relates to an information processing method, an information processing program, and an information processing system.

### 2. Description of the Related Art

A generative artificial intelligence (AI) that extracts features corresponding to information input by a user from a large amount of preliminarily learned data and that derives and outputs an appropriate answer is gaining widespread use.

The generative AI needs pre-learning, but cannot learn enough in advance in terms of following information whose disclosure range is limited and which cannot be accessed on the Internet, or information that is updated over time such as the latest update information. Accordingly, the generative AI cannot generate an appropriate answer to a question related to these pieces of information.

As one of various kinds of means to solve this problem, there is a retrieval-augmented generation (RAG) technology. When generating an answer to a question made for the generative AI, the RAG acquires relevant information related to the question from an external database or the like, adds the relevant information to the question, and inputs it to the generative AI, so that it is possible to cause the generative AI to generate and acquire an answer based on the relevant information.

Here, as a method for acquiring relevant information from an external database (a Web site or the like), a technique for analyzing, for example, a tree structure of a Web site and extracting relevant data from branch and leaf pages by keyword matching has been disclosed (see, for example, Japanese Patent Laid-open No. 2020-98596).

### SUMMARY OF THE INVENTION

By using the prior art disclosed in Japanese Patent Laid-open No. 2020-98596, relevant information can be acquired from a Web site. However, this method is not suitable for the RAG because it is intended to acquire a large amount of data for use in data analysis and machine learning.

That is, in the case of the generative AI that handles text, since the number of characters allowed to be input is limited, a large amount of data that can be acquired by such a prior art as Japanese Patent Laid-open No. 2020-98596 cannot be given as relevant information used for the RAG. For this reason, it is desirable to extract relevant information by narrowing down to a necessary minimum such that it falls within the number of characters allowed to be input into the generative AI.

The present invention has been made in view of the above problems, and an object thereof is to acquire relevant information that is acquired from an external database or the like and input to a generative AI, in an appropriate amount of data.

In order to solve the above problems, according to the present invention, there is provided an information processing method executed by an information processing system that acquires, from a Web page, relevant information related to a question to be input to a generative artificial intelligence for generating an answer to the question, the information processing system including a processor and a memory. The information processing method includes, by the processor, managing semantic rule information including a semantic rule for acquiring, as linkage information, information in the Web page whose semantic linkage is specified on the basis of grammar of a source code of the Web page and cyclic rule information including a cyclic rule for defining a cyclic order of a plurality of the Web pages at a time of acquisition of the relevant information, acquiring the cyclic rule from the cyclic rule information, acquiring the semantic rule from the semantic rule information, and circulating the plurality of Web pages on the basis of the acquired cyclic rule to acquire the linkage information from each of the circulated Web pages on the basis of the semantic rule, as the relevant information.

According to a representative embodiment of the present invention, it is possible to acquire, from a Web site, relevant information related to a question concerning contents described only in a Web site with a limited disclosure range, latest update information recently disclosed on a Web site, and the like, and to extract the information in an appropriate amount of data that is allowed to be input to the generative AI. Hence, a RAG system with high answering accuracy can be realized.

### BRIEF DESCRIPTION OF THE DRAWINGS

FIG. 1 is a diagram for depicting a configuration of a computer system according to an embodiment;

FIG. 2 is a diagram for depicting a chat screen for question input according to the embodiment;

FIG. 3 is a diagram for depicting a chat screen for answer output according to the embodiment;

FIG. 4 is a flowchart for depicting question answering processing according to the embodiment;

FIG. 5 is a diagram for depicting a processing outline of keyword extraction processing in the question answering processing according to the embodiment;

FIG. 6 is a flowchart for depicting relevant data extraction processing in the question answering processing according to the embodiment;

FIG. 7A is a diagram for depicting a processing outline of data extraction processing according to the embodiment;

FIG. 7B is a diagram for depicting the processing outline of the data extraction processing according to the embodiment;

FIG. 8 is a diagram for depicting a processing outline of pruning processing in the relevant data extraction processing according to the embodiment;

FIG. 9 is a diagram (Part 1) for depicting a processing outline of additional acquisition of relevant information according to the embodiment;

FIG. 10 is a diagram (Part 2) for depicting a processing outline of additional acquisition of relevant information according to the embodiment;

FIG. 11 is a diagram (Part 3) for depicting a processing outline of additional acquisition of relevant information according to the embodiment;

FIG. 12 is a diagram for depicting a processing outline of recursive relevant information acquisition according to the embodiment;

FIG. 13 is a diagram for depicting a processing outline of execution order alignment of recursively acquired relevant information according to the embodiment;

FIG. 14 is a diagram for depicting a processing outline of execution order alignment based on a semantic rule according to the embodiment; and

FIG. 15 is a diagram for depicting a processing outline of the execution order alignment based on the semantic rule according to the embodiment.

### DESCRIPTION OF THE PREFERRED EMBODIMENT

In the following description, a “memory” means one or more memory devices and may typically mean a main storage device. At least one memory device in the memory may be a volatile memory device or a non-volatile memory device.

In addition, in the following description, a “permanent storage device” means one or more permanent storage devices. The permanent storage device is typically a non-volatile storage device (for example, an auxiliary storage device) and is specifically, for example, a hard disk drive (HDD) or a solid state drive (SSD).

In addition, in the following description, a “storage device” may mean either the “memory” or the “permanent storage device.”

In addition, in the following description, a “processor” means one or more processor devices. At least one processor device is typically a microprocessor device such as a central processing unit (CPU) but may be any other types of processor devices such as a graphics processing unit (GPU). In addition, at least one processor device may be of a single core or a multi-core. In addition, at least one processor device may be a processor core. In addition, at least one processor device may be a processor device in a broad sense such as a hardware circuit (for example, a field-programmable gate array (FPGA) or an application specific integrated circuit (ASIC)) that performs part or all of processing.

In addition, in the following description, information from which an output is obtained with respect to an input is described using such an expression as an “xxx table” in some cases, but the information may be data of any structure or such a learning model as a neural network for generating an output with respect to an input. Therefore, the “xxx table” can be paraphrased as “xxx information.” In addition, in the following description, the configuration of each table is an example, and one table may be divided into two or more tables, all or some of two or more tables may constitute one table, or some unillustrated data fields may be included.

In addition, in the following description, processing is described using a “program” as the subject in some cases, but since the program is executed by a processor to perform defined processing while appropriately using a storage device, an interface device, and/or the like, the subject of the processing may be a processor (alternatively, such a device as a controller having the processor). The program may be installed from a program source to such a device as a computer. The program source may be, for example, a program distribution server or a computer-readable (for example, non-transitory) recording medium. In addition, in the following description, two or more programs may be realized as one program, or one program may be realized as two or more programs.

In addition, in the following description, a function is described using such an expression as an “xxx part” in some cases, but the function may be realized by a processor executing one or more computer programs, or may be realized by one or more hardware circuits (for example, an FPGA or an ASIC). In the case where a function is realized by a processor executing one or more programs, the function may be at least a part of the processor since defined processing is performed with a storage device, an interface device, and/or the like appropriately used.

In addition, processing described using a function as the subject may be processing performed by a processor or a device having the processor. In addition, a program may be installed from a program source. The program source may be, for example, a program distribution computer or a computer-readable recording medium (for example, a non-transitory recording medium). The description of each function is an example, and a plurality of functions may be combined into one function, or one function may be divided into a plurality of functions.

In addition, in the following description, a “computer system” means a system including one or more physical computers. The physical computer may be a general-purpose computer or a dedicated computer.

In addition, control lines and information lines considered to be necessary for explanation are depicted, and all the control lines and information lines necessary for implementation are not necessarily depicted. In practice, almost all the configurations may be considered to be connected to one another.

Hereinafter, a set of one or more computers that manages an information processing system and displays information for display of the present embodiment will be referred to as a management system in some cases. In the case where a computer for management (hereinafter, a management computer) displays information for display, the management computer is a management system. A combination of the management computer and a computer for display is also a management system. In addition, in order to increase the speed and reliability of management processing, processing equivalent to that of the management computer may be realized by a plurality of computers, and in this case, the plurality of computers (including a computer for display in the case where display is performed by the computer for display) constitute the management system. The management computer is an example of an information processing system that executes an information processing method on the basis of an information processing program.

Hereinafter, one embodiment of the present invention will be described in detail with reference to the drawings.

### (Configuration of Whole System S According to Embodiment)

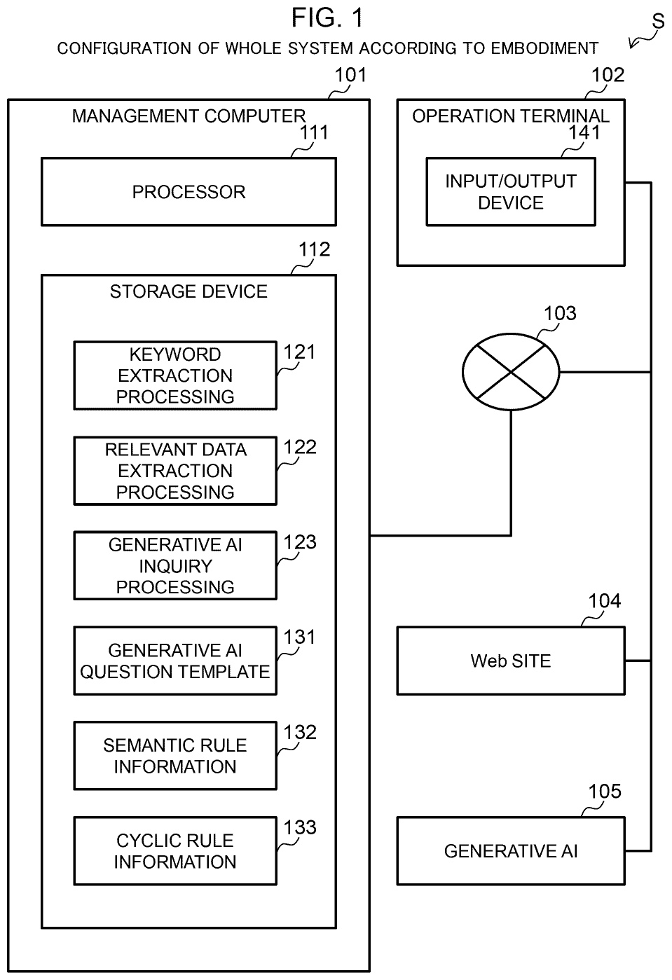

FIG. 1 is a diagram for depicting a configuration of a whole system S according to an embodiment. The whole system S is a system in which a management computer 101, an operation terminal 102, a Web site 104, and a generative AI 105 are connected to one another via a network 103.

The management computer 101 receives a question input by a user from an input/output device 141 of the operation terminal 102. The management computer 101 causes a processor 111 to execute keyword extraction processing 121, relevant data extraction processing 122, and generative AI inquiry processing 123 recorded in a storage device 112. The management computer 101 extracts information related to the question (hereinafter, referred to as “relevant information”) from information acquired from the Web site 104 by execution of these kinds of processing. The management computer 101 provides the relevant information and the question to the generative AI 105 and displays an output result of the generative AI 105 on the input/output device 141.

The management computer 101 has the processor 111 and the storage device 112. The management computer 101 may have an input/output device that is not illustrated. Here, the input/output device is, for example, a touch panel, a display, a keyboard, a mouse, and the like. The processor 111 executes the keyword extraction processing 121, the relevant data extraction processing 122, and the generative AI inquiry processing 123.

The storage device 112 stores the keyword extraction processing 121, the relevant data extraction processing 122, the generative AI inquiry processing 123, a generative AI question template 131, semantic rule information 132, and cyclic rule information 133. The processing and information stored in the storage device 112 may be stored in storage devices that are different from each other, or may be stored in a storage device, which is not illustrated, connected via the network 103.

The generative AI question template 131 is template information concerning a question sentence used when the keyword extraction processing 121, the relevant data extraction processing 122, and the generative AI inquiry processing 123 generate a question to be transmitted to the generative AI 105 via the network 103. The question sentence is generated by inputting of necessary information according to the generative AI question template 131.

The semantic rule information 132 manages a semantic rule recording patterns for extracting relevant information related to a question from a Web page when the relevant data extraction processing 122 acquires information from the Web site 104 via the network 103. The semantic rule is, for example, a rule indicating a semantic connection between pieces of information based on a correspondence relation between elements of a Web page. Each semantic rule included in the semantic rule information 132 may be held as, for example, a function for scraping a Web page.

When the relevant data extraction processing 122 acquires information from the Web site 104 via the network 103, the cyclic rule information 133 manages cyclic rule information in which patterns of an acquisition order for newly acquiring hypertext markup language (HTML) information as page information are recorded, such as page feeding or acquisition of a pop-up screen in a Web site. A cyclic rule can also be said to be a rule that defines a cyclic order of circulating Web pages on the basis of page feeding and a transition rule to a dependent page. For example, the rule may be stored as program information for controlling a Web driver that accesses a Web page.

The semantic rule and the cyclic rule depend on a source code of a Web page.

The generative AI question template 131, the semantic rule information 132, and the cyclic rule information 133 may be manually created, may be created by some program, or may be held in some alternative form.

The network 103 is a communication path connected in a wired or wireless manner. For example, the network 103 is a wired or wireless local area network (LAN) but is not limited thereto.

The Web site 104 is a server that operates on a plurality of computer systems (not illustrated) on the Internet connected via the network 103 and that stores and provides information provided by a company, an individual, a public institution, or many other unspecified parties.

The generative AI 105 is one kind of artificial intelligence that operates on a plurality of computer systems (not illustrated) on the Internet connected via the network 103, and outputs sound, images, and text corresponding to an input on the basis of previously learned contents. In the present invention, the generative AI 105 specifically refers to artificial intelligence that handles text.

### (Chat Screen 200 for Question Input According to Embodiment)

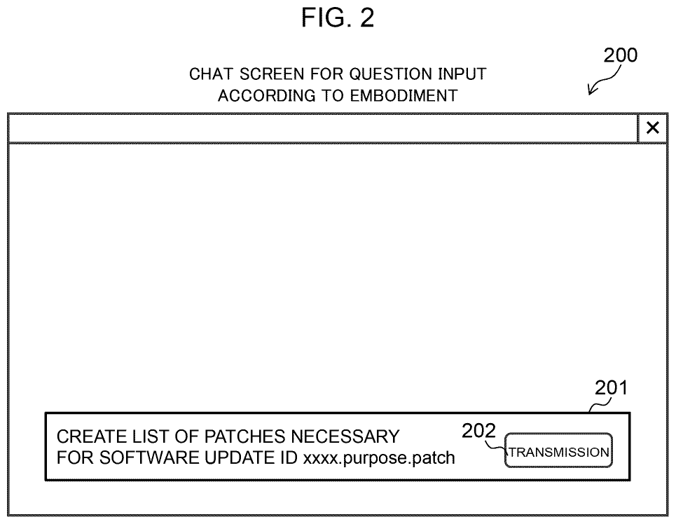

FIG. 2 is a diagram for depicting a chat screen 200 for question input according to the embodiment of the present invention. The chat screen 200 is displayed on the input/output device 141 of the operation terminal 102. The chat screen 200 includes an input field 201 for the user to input a question sentence and a transmission button 202 for transmitting the input question sentence.

### (Chat Screen 200 for Answer Output According to Embodiment)

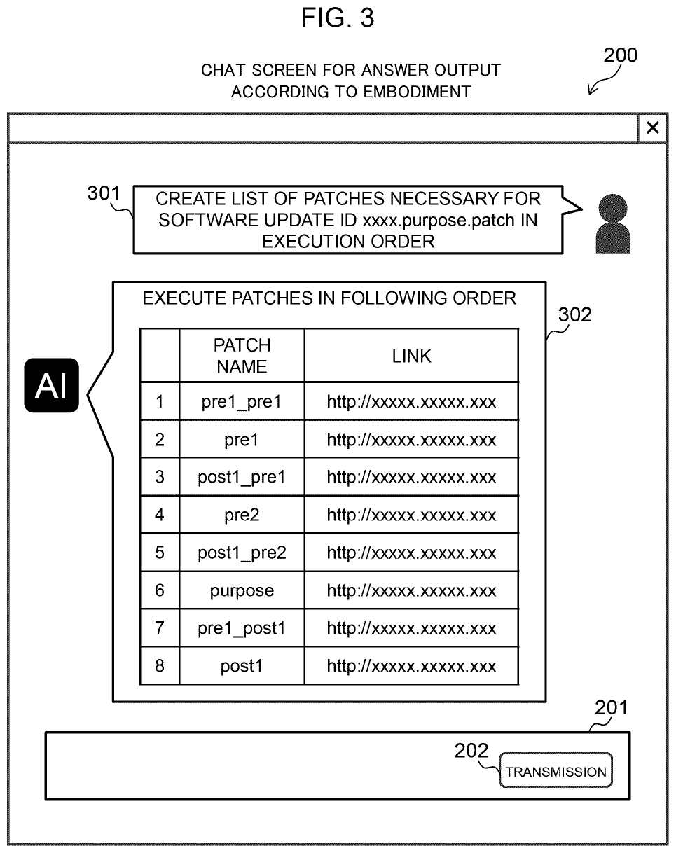

FIG. 3 is a diagram for depicting a chat screen 200 for answer output according to the embodiment. FIG. 3 depicts a screen similar to the chat screen 200 exemplified in FIG. 2, and includes an input field 201 for the user to input a question sentence and a transmission button 202 for transmitting the input question sentence. The chat screen 200 in FIG. 3 additionally displays a display field 301 for a question history received as inputs from the user and a display field 302 for an answer of the computer system to the question.

(Question Answering Processing for Answering Question from User According to Embodiment)

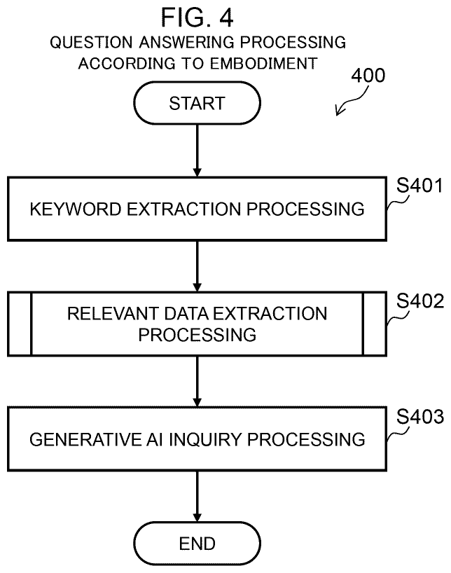

FIG. 4 is a flowchart for depicting an example of a question answering processing procedure in which the management computer 101 according to the embodiment answers a question from the user. A question answering processing flow 400 exemplified in the flowchart may be executed by reception of a question sentence input via the chat screen 200 displayed on the input/output device 141 of the operation terminal 102. Alternatively, it may be executed by an instruction of some program.

As depicted in FIG. 4, the processor 111 of the management computer 101 executes the keyword extraction processing (S401), the relevant data extraction processing (S402), and the generative AI inquiry processing (S403). The question answering processing flow 400 may include other processing steps that are not illustrated, and some of processing steps may be omitted or replaced with alternative processing steps, an execution order may be switched, or some of processing steps may be executed in parallel, within a scope not causing any discrepancy in input and output.

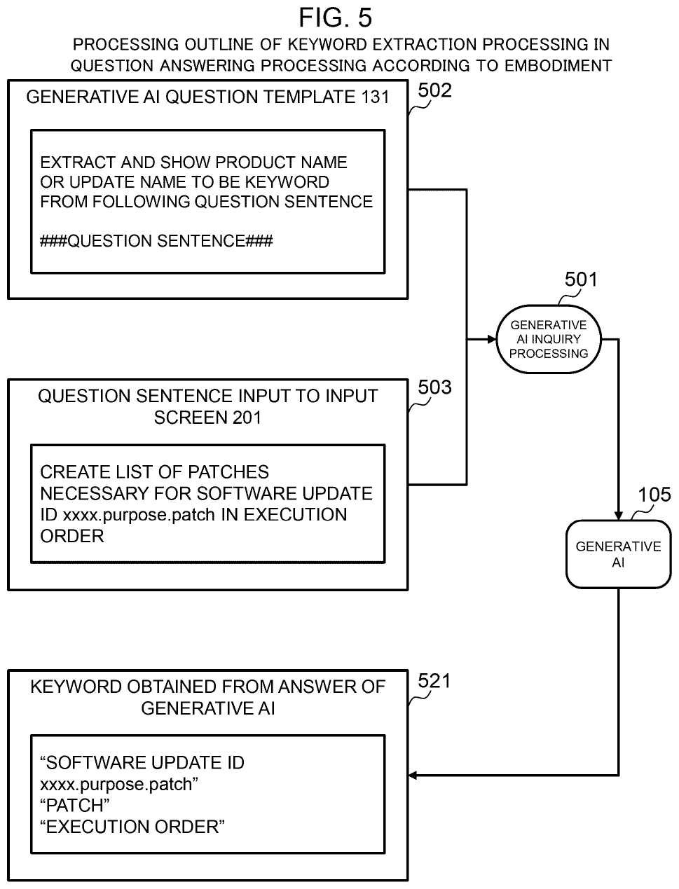

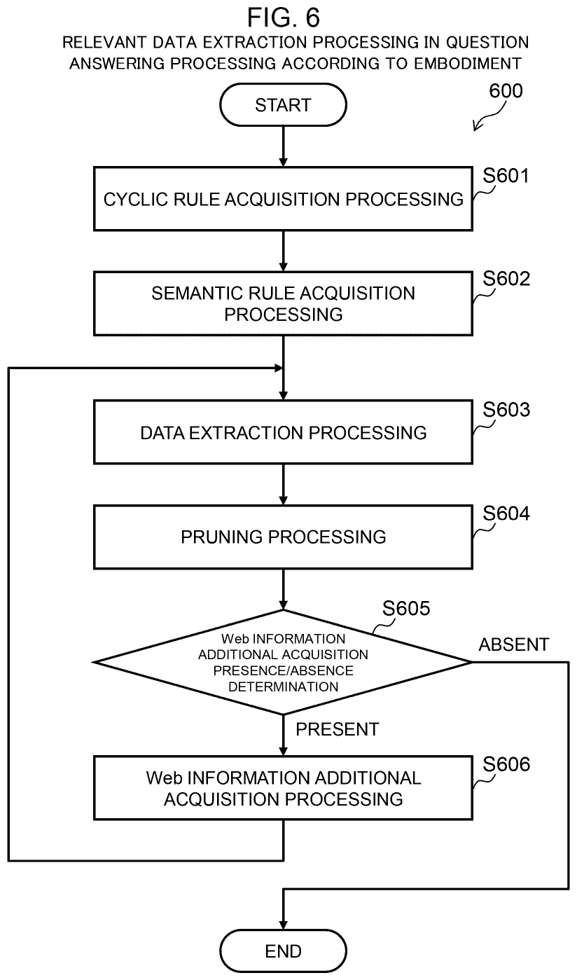

The keyword extraction processing (S401) will be described later using FIG. 5, and the relevant data extraction processing (S402) will be described later using FIG. 6. The relevant information extracted by the relevant data extraction processing can be used by being provided for manual analysis by the user or for other purposes.

In the generative AI inquiry processing (S403), the processor 111 combines the question sentence received via the chat screen 200 with the relevant information concerning the question acquired from the Web site by the relevant data extraction processing (S402), to create a question sentence for the generative AI according to the generative AI question template 131. Then, the processor 111 inputs the question sentence to the generative AI for inquiry and acquires an output of the generative AI.

### (Processing Outline of Keyword Extraction Processing in Question Answering Processing According to Embodiment)

FIG. 5 is a diagram for depicting a processing outline of the keyword extraction processing (S401) in the question answering processing flow 400 according to the embodiment. In the keyword extraction processing 121, the processor 111 executes a generative AI inquiry processing module 501, combines a template 502 stored in the generative AI question template 131 with a question sentence 503 input to the input field 201, to create a question sentence for the generative AI 105, and inputs it to the generative AI 105. Then, the processor 111 receives an output 521 from the generative AI 105, so that a keyword necessary for collecting relevant information necessary for answering the question sentence is extracted.

In FIG. 5, the keyword extraction processing exemplifies processing using the generative AI 105, but, instead of using the generative AI 105, for example, different means such as rule-based data extraction or collation with a keyword list may be used, or a combination of several kinds of means may be used.

### (Relevant Data Extraction Processing According to Embodiment)

FIG. 6 is a flowchart for exemplifying an example of a processing procedure of the relevant data extraction processing (S402) in the question answering processing flow 400 according to the embodiment. In a relevant data extraction processing flow 600 exemplified in the flowchart, the processor 111 executes cyclic rule acquisition processing (S601), semantic rule acquisition processing (S602), data extraction processing (S603), pruning processing of the acquired information (S604), a Web information additional acquisition presence/absence determination (S605), and Web information additional acquisition processing (S606). The relevant data extraction processing flow 600 may include other processing steps that are not illustrated, and some of processing steps may be omitted or replaced with alternative processing steps, an execution order may be switched, or some of processing steps may be executed in parallel, within a scope not causing any discrepancy in input and output.

In the cyclic rule acquisition processing (S601), the processor 111 acquires, from the cyclic rule information 133, an appropriate cyclic rule according to the keyword of the question acquired in the keyword extraction processing (S401) and a target Web site necessary for collecting relevant information. For example, any semantic rule may be defined for each Web site or each keyword, and acquisition may be made by such a method as keyword search.

In the semantic rule acquisition processing (S602), the processor 111 acquires an appropriate semantic rule from the semantic rule information 132, according to the keyword of the question acquired in the keyword extraction processing (S401) and the Web site necessary for collecting relevant information. For example, any semantic rule may be defined for each Web site or each keyword, and acquisition may be made by such a method as keyword search.

In the data extraction processing (S603), the processor 111 acquires semantically connected information from the source code of the Web page in accordance with the semantic rule acquired in the semantic rule acquisition processing (S602).

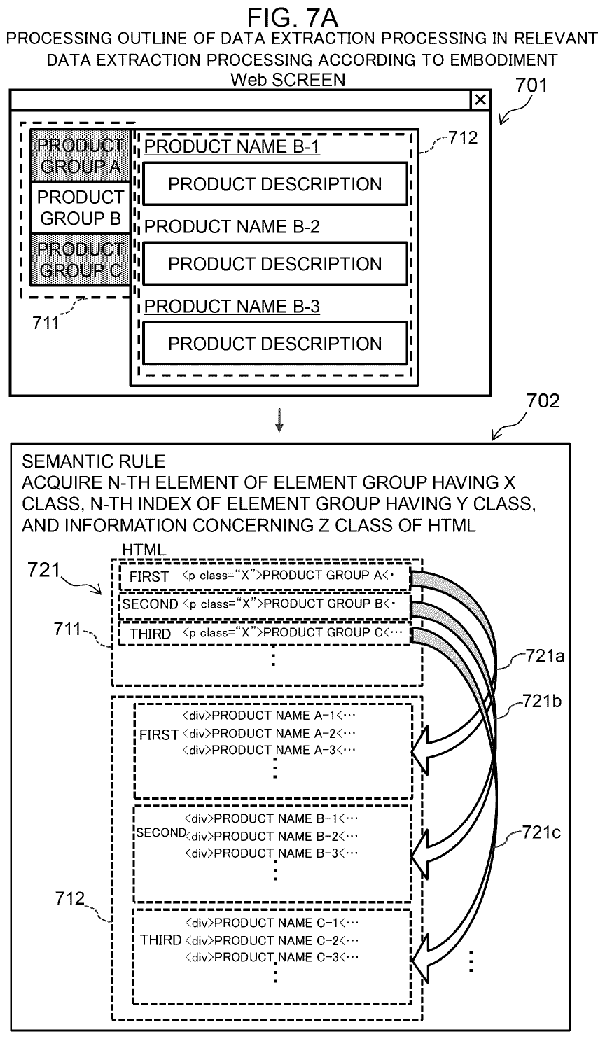

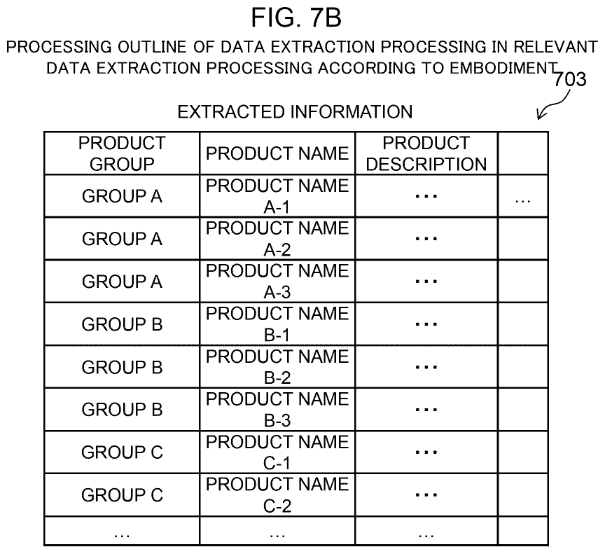

FIG. 7A and FIG. 7B are schematic views for exemplifying the data extraction processing (S603). For example, as exemplified in a Web screen 701, in the case where there is a Web site screen on which various products are introduced by tab display for each product group, information is extracted in accordance with an exemplified semantic rule 702, and exemplified extracted information 703 is extracted.

The semantic rule 702 is a rule for identifying a semantic linkage between pieces of information on the basis of, for example, grammar of the source code of the Web page and acquiring semantically linked pieces of information in the Web page as linkage information.

The semantic rule 702 is “acquire the N-th (N=1, 2, and the like) element of an element group having an X class, the N-th index of an element group having a Y class, and information concerning a Z class of HTML” in the example of FIG. 7A. The semantic rule 702 indicates that a “product group,” a “product name,” a “product description,” and the like are acquired on the basis of correspondence relations 721a, 721b, 721c, and the like between the Web screen 701 and a source code 721 for each N-th element of a tab 711 and information 712. As a result of the extraction based on the semantic rule 702, the extracted information 703 including the “product group,” “product name,” and “product description” exemplified in FIG. 7B is extracted.

HTML, which is the source code of recent Web sites, has a large number of characters of the source code per page, ranging from hundreds of thousands to over one million characters. In addition, since display is controlled by combination with cascading style sheets (CSS) and JavaScript (registered trademark), it is difficult to acquire semantic connections only by HTML. In division by the number of characters of the source code, which is used as a general method, it is rare that relevant information is gathered in a group. Further, the semantic connections are expressed by switching of the display by CSS or JavaScript (registered trademark) in many cases, and it is difficult to gather the relevant information only by proximity of source codes of HTML or general keyword matching. In the present embodiment, semantically relevant pieces of information described at remote places on HTML can be collected in accordance with the semantic rule.

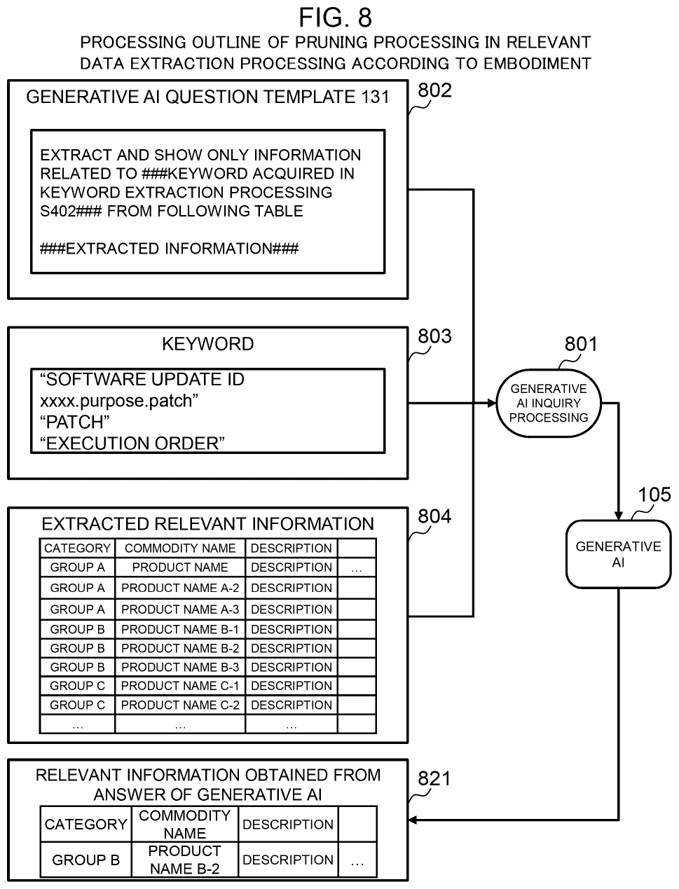

FIG. 8 is a schematic view for exemplifying the pruning processing (S604) in the relevant data extraction processing according to the embodiment. For example, in generative AI inquiry processing 801, a question sentence for the generative AI 105 is created by combination of template information 802 recorded in the generative AI question template 131, a keyword 803 of the question acquired in the keyword extraction processing (S401), and relevant information 804 acquired in the data extraction processing (S603), an inquiry is made to the generative AI 105, and relevant information 821 is acquired. Further, the relevant information acquired from the Web site 104 is pruned to leave only the relevant information 821 directly connected to the answer to the question.

It should be noted that FIG. 8 exemplifies the pruning processing (S604) using the generative AI 105, but instead of using the generative AI 105, for example, other means such as rule-based data pruning or character string matching data pruning may be used, or several kinds of means may be carried out in combination.

In the Web information additional acquisition presence/absence determination processing (S605), it is determined whether or not there is information to be additionally acquired from the Web site, in accordance with the cyclic rule acquired in the cyclic rule acquisition processing (S602). For example, it is determined whether or not additional information is to be acquired by page feeding or whether or not more detailed information is to be acquired by drill-down of the Web site. In the case where it is determined in the additional acquisition presence/absence determination processing (S605) that there is detailed information to be acquired by drill-down of the Web site, the flow moves to S606, and in the case where it is determined that there is no such detailed information, the relevant data extraction processing is terminated.

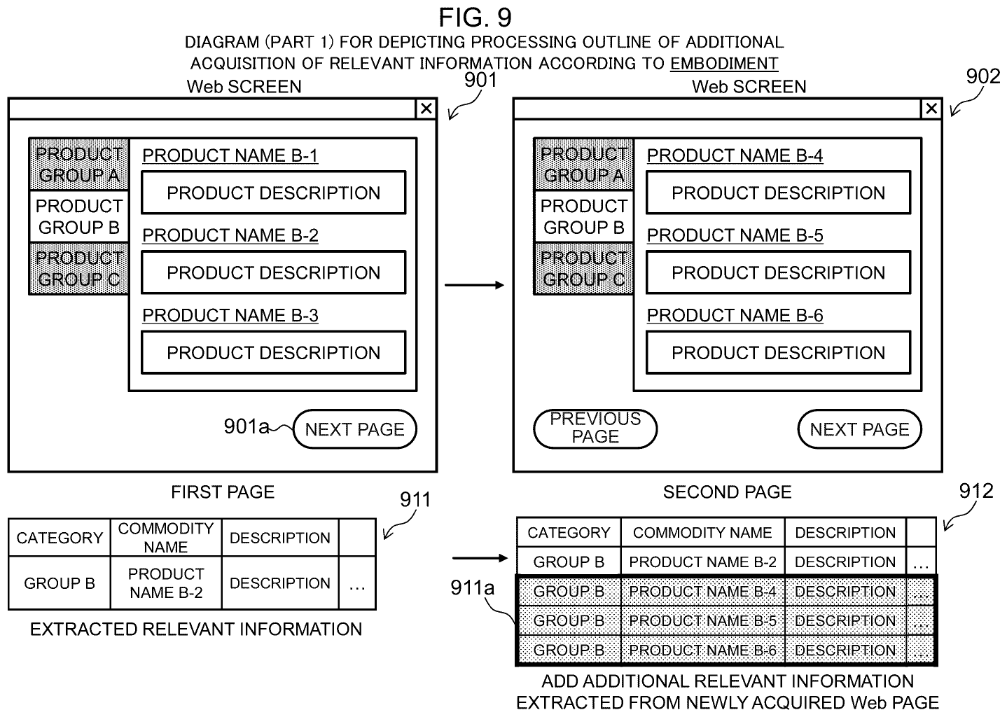

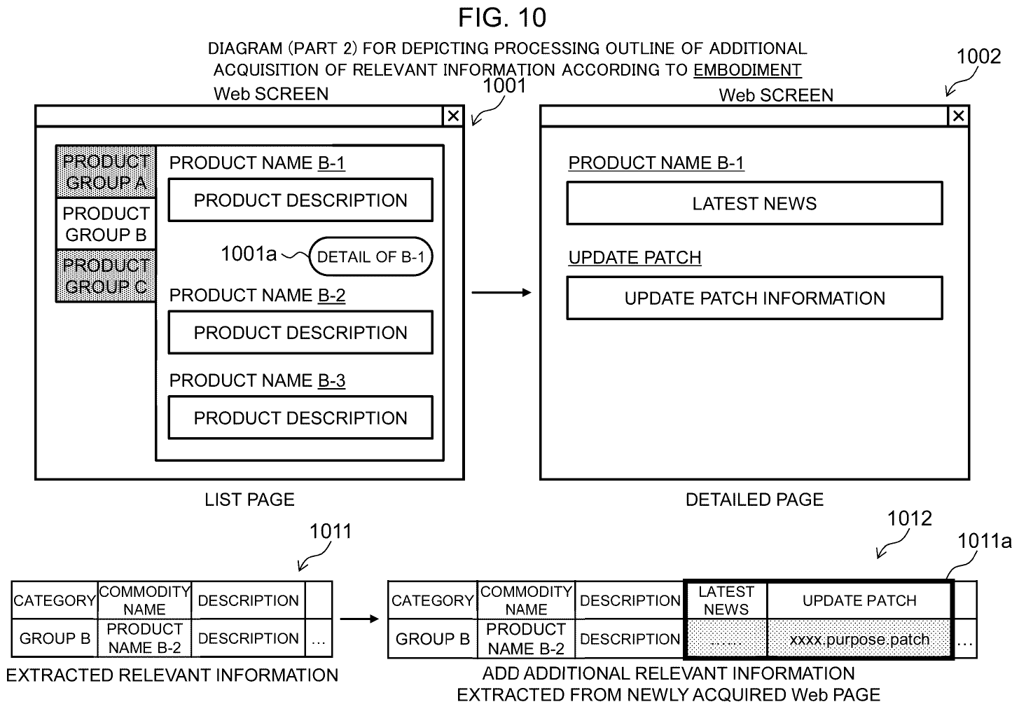

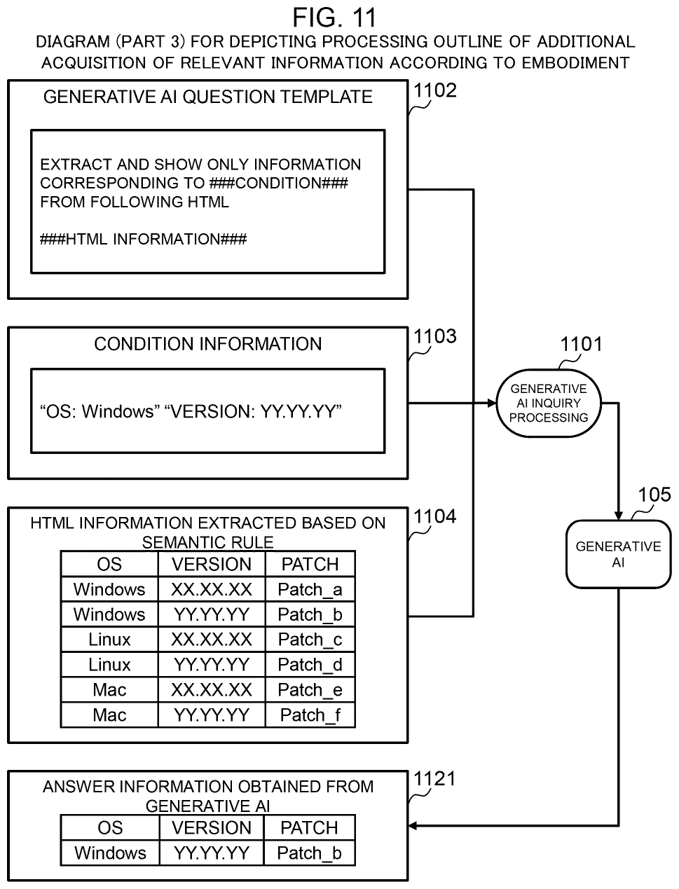

FIG. 9, FIG. 10, and FIG. 11 are diagrams for depicting processing outlines (Part 1 to Part 3) of additional acquisition of the relevant information by the Web information additional acquisition processing (S606).

FIG. 9 depicts a first processing outline of additional acquisition of relevant information. FIG. 9 is an explanatory diagram of an example in the case where HTML is newly acquired from the Web site in accordance with the cyclic rule and a row of relevant information is additionally acquired in the Web information additional acquisition processing (S606). In FIG. 9, in the case where a page feeding button 901a is present in an originally displayed Web page 901, the page feeding button 901a is pressed to acquire a Web page 902. At this time, additional relevant information 911a (hatched portion illustrated in relevant information 912) acquired from the newly acquired Web page 902 is added to relevant information 911 acquired and pruned from the originally displayed Web page 901.

FIG. 10 depicts a second processing outline of additional acquisition of relevant information. FIG. 10 is an explanatory diagram of an example in the case where HTML is newly acquired from the Web site in accordance with the cyclic rule and a row of relevant information is additionally acquired in the Web information additional acquisition processing (S606). In FIG. 10, in an originally displayed Web page 1001, a link button 1001a to another page publishing more detailed information is pressed, and a Web page 1002 is acquired. At this time, additional relevant information 1011a (hatched portion illustrated in relevant information 1012) acquired from the newly acquired Web page 1002 is added to relevant information 1011 acquired and pruned from the originally displayed Web page 1001.

FIG. 11 depicts a third processing outline of additional acquisition of relevant information. FIG. 11 illustrates an outline of processing for selecting an appropriate link in accordance with the cyclic rule in the Web information additional acquisition processing (S606) in the case where the structure of the Web site is of a drill-down type with links for acquiring more detailed information and conditional branches of links to be followed occur depending on conditions. A generative AI inquiry processing module 1101 creates a question sentence for the generative AI 105 by combining generative AI question template information 1102, condition information 1103, and HTML information 1104 in which a link acquired from the Web page by the semantic rule is described. Then, an inquiry is made to the generative AI 105, and answer information 1121 in which link information to be acquired is described is acquired from the generative AI 105.

As a result, link information unrelated to the system can be excluded, an appropriate link can be selected, and extra information that causes hallucination can be excluded from the relevant information given by the RAG. The condition information 1103 handled here refers to information necessary for selection concerning a conditional branch, is, for example, information such as operating system (OS) information or a software version, and may be manually input, may be defined in advance in, for example, a setting file, or may be acquired by some program such as a system call.

In addition, FIG. 11 exemplifies processing of selecting an acquisition destination link in the Web information additional acquisition processing (S606) by using the generative AI 105. However, instead of using the generative AI 105, for example, other means such as rule-based data pruning may be used, or some means may be carried out in combination.

As described with reference to FIG. 6, FIG. 7A, FIG. 7B, FIG. 8, FIG. 9, FIG. 10, and FIG. 11, relevant information related to the question can be acquired from the Web site by the relevant data extraction processing 122. For example, considering the case of handling update patches of software, a prerequisite patch for applying an update patch and an ex-post patch for a stable operation may exist. Regarding the prerequisite patch and the ex-post patch, it is conceivable that a further prerequisite patch and a further ex-post patch exist. In order to cope with such a case, relevant information may be acquired more comprehensively by recursively executing the relevant data extraction processing 122 described above.

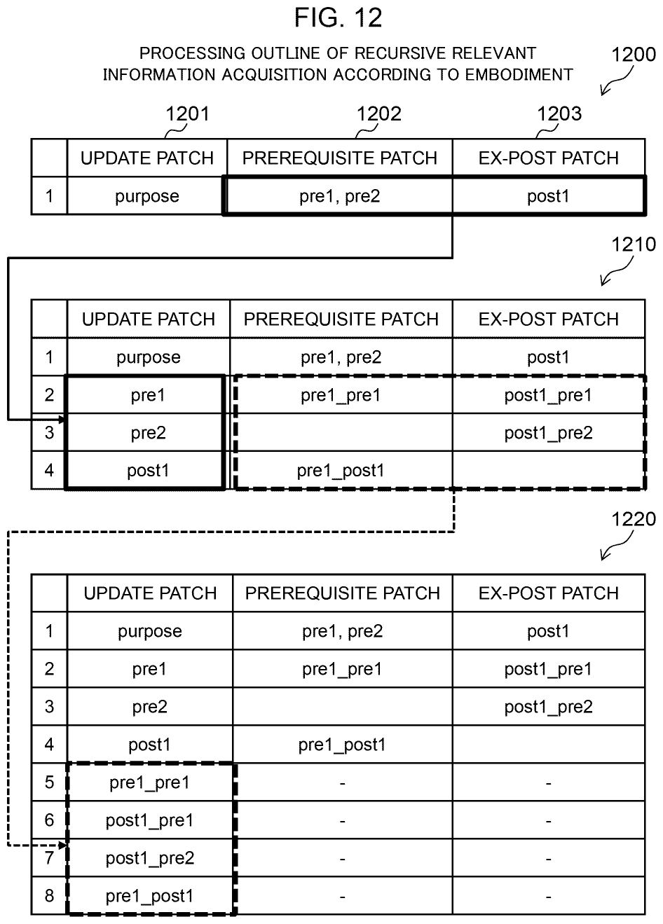

FIG. 12 is a diagram for depicting a processing outline of recursive relevant information acquisition according to the embodiment. As depicted in FIG. 12, prerequisite patches and ex-post patches can be comprehensively acquired by recursive execution of the relevant data extraction processing 122. In the recursive relevant information acquisition, there is a table depicted as a table 1200 as an excerpt of information acquired from the Web site by the semantic rule. The table 1200 includes an update patch 1201, a prerequisite patch 1202, and an ex-post patch 1203.

The table 1200 stores data of relevant information (the prerequisite patch 1202 and the ex-post patch 1203) acquired by first execution of the relevant data extraction processing 122 with the update patch 1201 as an input. The prerequisite patch 1202 is a patch that is already executed at the time when the update patch 1201 is executed, as a prerequisite. The ex-post patch 1203 is a patch executed successively after the execution of the update patch 1201.

Then, a table 1210 stores data of relevant information (the prerequisite patch and the ex-post patch) further acquired by second execution of the relevant data extraction processing 122, with each of the prerequisite patch and ex-post patch acquired by the first execution being regarded as a target update patch.

Similarly, a table 1220 stores data of relevant information (the prerequisite patch and the ex-post patch) further acquired by third execution of the relevant data extraction processing 122, with each of the prerequisite patch and ex-post patch acquired by the second execution being regarded as a target update patch. It should be noted that, in the case where both the prerequisite patch and the ex-post patch do not exist, the recursive relevant information acquisition is not executed, and hence, they may be deleted from the tables 1200, 1210, 1220, and the like.

As exemplified in FIG. 12, by recursively executing the relevant data extraction processing, information necessary for software update can be comprehensively acquired. In addition, as exemplified in FIG. 12, in the case where the processing is to be recursively executed, it is desirable to set some termination condition in advance such that the processing does not get caught in an infinite loop. For example, the termination condition for the execution of the recursive processing may be set by any one of or a combination of some of methods such as setting an upper limit to the number of times of recursive execution, holding information concerning a list of patches that have already been applied and setting such that no prerequisite patch or ex-post patch is to be acquired for the applied patches by the recursive processing, or continuing the recursive processing until appearance of a further prerequisite patch or a further ex-post patch ends as depicted in the table 1220 of FIG. 12.

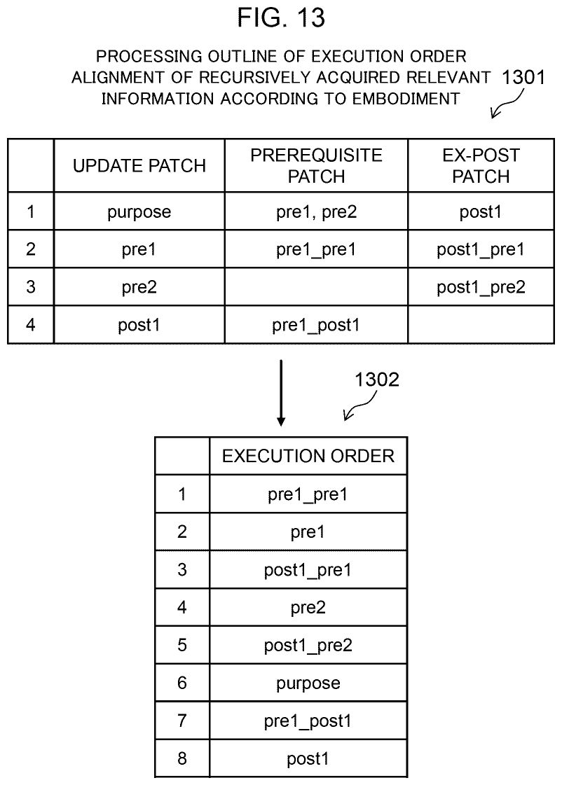

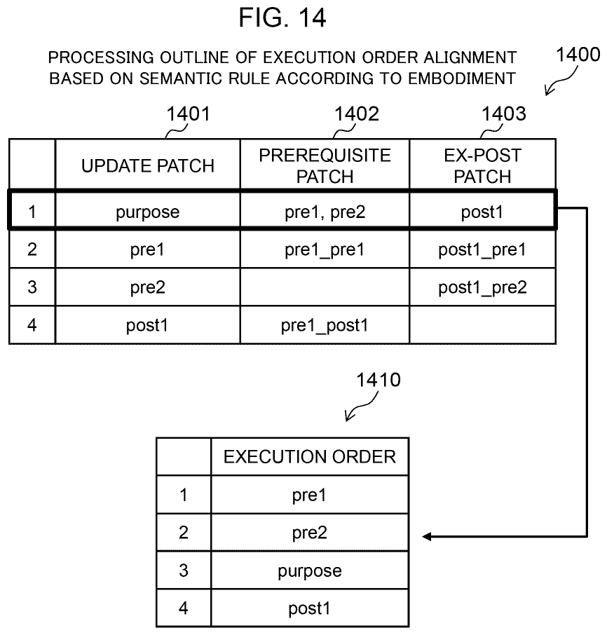

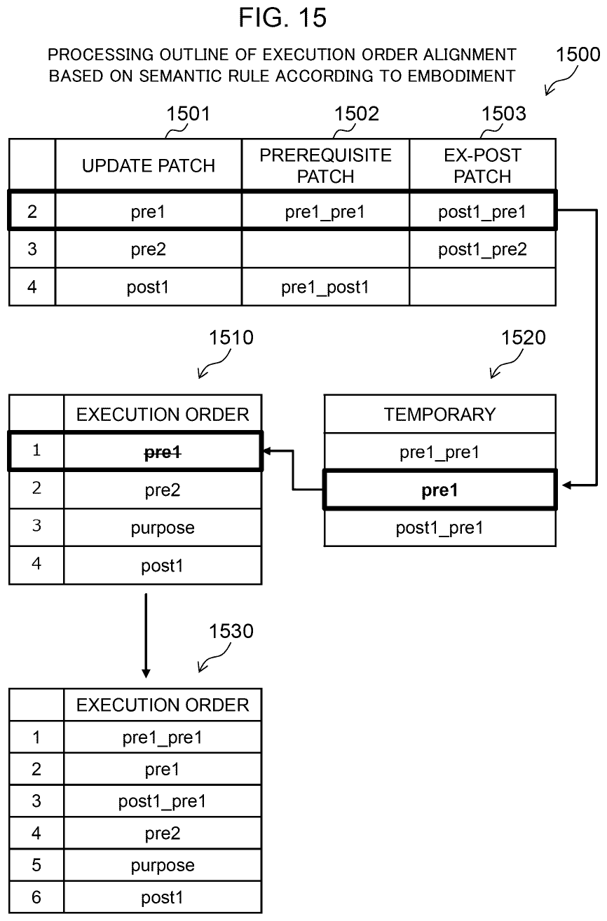

FIG. 13 is a diagram for depicting a processing outline of execution order alignment of the recursively acquired relevant information according to the embodiment. A table 1301 of FIG. 13 depicts a plurality of combinations of target patches, prerequisite patches, and ex-post patches acquired by recursive execution of the relevant data extraction processing 122. Since the order in which the patches are acquired and the order in which the patches are executed without causing a problem in an actual operation are different from each other, rearrangement without discrepancy in the execution order may be performed on the basis of the semantic rule, as exemplified in a table 1302, before the information is given to the generative AI 105 as the relevant information. An example of rearranging the execution order will be described by use of FIG. 14 and FIG. 15.

FIG. 14 is a diagram for depicting a processing outline of the execution order alignment based on the semantic rule according to the embodiment. In the case where the execution order of the update patch, the prerequisite patch, and the ex-post patch is rearranged by the semantic rule, a table including an update patch 1401, a prerequisite patch 1402, and an ex-post patch 1403 is first prepared as exemplified as a table 1400. Then, the data stored in the first row is extracted from the table 1400, and an execution order table 1410 rearranged in the order of the prerequisite patch 1402, the target update patch 1401, and the ex-post patch 1403 is created. As exemplified in a table 1500 of FIG. 15, because the first row at the head is extracted, the table 1400 is changed to a state in which the data of the first row has been excluded.

In the processing of the rearrangement to the execution order, the first row at the head is extracted again from the table 1500, and a temporary table 1520 rearranged in the order of a prerequisite patch 1502, an update patch 1501, and an ex-post patch 1503 is created as with the case of creating the execution order table 1410. Then, an update patch column obtained when the temporary table 1520 is created is compared with elements in an execution order table 1510 (same as the execution order table 1410), the element in a matching place is deleted, and the temporary table 1520 is interposed in the deleted place, so that a new execution order table 1530 is created. By repeating the processing exemplified in FIG. 15 until the table 1500 becomes empty, the patches can be rearranged in the order causing no problem as the execution order.

In the generative AI inquiry processing 123, the relevant information related to the question extracted from the Web site 104 by the above-described processing and the question information received from the input/output device 141 of the operation terminal 102 are formed according to the information described in the generative AI question template 131, and a question sentence to be input to the generative AI 105 is created. Then, an inquiry is made to the generative AI 105, an output therefrom is received, and the received result is displayed on the input/output device 141 of the operation terminal 102.

### Effects of Embodiment

In the above-described embodiment, one or more Web pages are circulated on the basis of the cyclic rule, and linkage information is acquired as relevant information from each of the circulated Web pages on the basis of the semantic rule. Accordingly, according to the embodiment, it is possible to acquire a block of useful pieces of information that are semantically connected to each other, in accordance with the semantic rule and the cyclic rule from the Web site. In addition, only appropriate relevant information the amount of which fits within the number of tokens of the generative AI can be extracted, and it is possible to obtain a highly accurate answer by the RAG.

In addition, in the above-described embodiment, an instruction to delete information unrelated to the keyword from the relevant information acquired from one or more Web pages is input to the generative AI, and the relevant information from which the information unrelated to the keyword has been deleted by the generative AI in response to the instruction is acquired. Accordingly, according to the embodiment, relevance to the question is determined for each Web page, the information is narrowed down, and only the information necessary for answering the question can be collected as relevant information.

In addition, in the above-described embodiment, relevant information is additionally acquired on the basis of the semantic rule newly from the Web page of the transition destination after transition based on the cyclic rule. Accordingly, it is possible to widely collect relevant information without omission and with high comprehensiveness.

In addition, in the above-described embodiment, detailed information of the relevant information acquired from the Web page of the transition source on the basis of the cyclic rule is additionally acquired on the basis of the semantic rule from the Web page of the transition destination after transition from the Web page of the transition source based on the cyclic rule. Accordingly, it is possible to widely collect relevant information without omission and with high comprehensiveness.

In addition, in the above-described embodiment, an instruction to extract relevant information matching predetermined condition information from the relevant information acquired from one or more Web pages is input to the generative AI, and the relevant information that matches the predetermined condition information and that is output from the generative AI in response to the instruction is acquired. Accordingly, according to the embodiment, it is possible to acquire the relevant information by narrowing down pieces of candidate information to highly useful information and obtain a highly accurate answer by the RAG.

In addition, in the above-described embodiment, the second relevant information is acquired on the basis of the first relevant information, the cyclic rule, and the semantic rule. Accordingly, according to the embodiment, the relevant information can be comprehensively acquired by recursively acquiring further relevant information on the basis of the acquisition result of the relevant information.

In addition, in the above-described embodiment, a plurality of pieces of information are acquired as the first relevant information and the second relevant information, and the processing order of the plurality of pieces of information is switched on the basis of the semantic rule. Accordingly, according to the embodiment, a plurality of processing steps (such as update patches of software) whose execution order is defined can be aligned in an executable manner from the acquired relevant information.

In addition, in the above-described embodiment, a question sentence is generated by combining the acquired relevant information with the question, the question sentence is input to the generative AI, and the answer output by the generative AI in response to the question sentence is acquired. Accordingly, according to the embodiment, it is possible to obtain a highly accurate answer by the RAG.

As described above, according to the embodiment of the present invention, the management computer 101 extracts information related to the question on the basis of the semantic rule for acquiring data from the Web site, the cyclic rule, and the inquiry template information for the generative AI, and obtains an answer by making an inquiry to the generative AI with a combination of the question and the relevant information, so that it is possible to obtain a correct answer that the generative AI would not be able to give without relevant knowledge. In addition, by deleting information that is not directly related to the question from the relevant information, it is possible to avoid a possibility that the generative AI gives an incorrect answer.

It should be noted that the present invention is not limited to the above-described embodiment and includes various modified examples and equivalent configurations within the gist of the appended claims. For example, the above-described embodiment has been described in detail in order to clearly explain the present invention, and the present invention is not necessarily limited to one having all the configurations described. In addition, a part of a configuration of one embodiment may be replaced with a configuration of another embodiment. In addition, a configuration of one embodiment may be added to a configuration of another embodiment. In addition, another configuration may be added, deleted, or replaced to/from/with a part of a configuration of each embodiment.

What is claimed is:

1. An information processing method executed by an information processing system that acquires, from a Web page, relevant information related to a question to be input to a generative artificial intelligence for generating an answer to the question,
the information processing system including a processor and a memory,
the information processing method comprising:
by the processor,
managing semantic rule information including a semantic rule for acquiring, as linkage information, information in the Web page whose semantic linkage is specified on a basis of grammar of a source code of the Web page, and cyclic rule information including a cyclic rule for defining a cyclic order of a plurality of the Web pages at a time of acquisition of the relevant information;
acquiring the cyclic rule from the cyclic rule information;
acquiring the semantic rule from the semantic rule information; and
circulating the plurality of Web pages on a basis of the acquired cyclic rule to acquire the linkage information from each of the circulated Web pages on a basis of the semantic rule as the relevant information.

2. The information processing method according to claim 1, further comprising:
by the processor,
extracting a keyword from a question sentence representing the question;
inputting, to the generative artificial intelligence, an instruction to delete information unrelated to the keyword from the relevant information acquired from the plurality of Web pages; and
acquiring the relevant information from which the information unrelated to the keyword has been deleted by the generative artificial intelligence in response to the instruction.

3. The information processing method according to claim 1, further comprising:
by the processor,
additionally acquiring, on the basis of the semantic rule, the relevant information newly from a Web page of a transition destination after transition based on the cyclic rule.

4. The information processing method according to claim 1, further comprising:
by the processor,
additionally acquiring, on the basis of the semantic rule, detailed information of the relevant information acquired from a Web page of a transition source based on the cyclic rule, from a Web page of a transition destination after transition from the Web page of the transition source based on the cyclic rule.

5. The information processing method according to claim 1, further comprising:
by the processor,
receiving an input of predetermined condition information;
inputting, to the generative artificial intelligence, an instruction to extract relevant information matching the predetermined condition information from the relevant information acquired from the plurality of Web pages; and
acquiring the relevant information that matches the predetermined condition information and that is output from the generative artificial intelligence in response to the instruction.

6. The information processing method according to claim 1, further comprising:
by the processor,
acquiring first relevant information; and
acquiring second relevant information on a basis of the first relevant information, the cyclic rule, and the semantic rule.

7. The information processing method according to claim 6, further comprising:
by the processor,
acquiring a plurality of pieces of information as the first relevant information and the second relevant information; and
switching a processing order of the plurality of pieces of information on the basis of the semantic rule.

8. The information processing method according to claim 1, further comprising:
by the processor,
generating a question sentence by combining the acquired relevant information with the question;
inputting the question sentence to the generative artificial intelligence; and
acquiring an answer output by the generative artificial intelligence in response to the question sentence.

9. A computer-readable recording medium on which a program for acquiring, from a Web page, relevant information related to a question to be input to a generative artificial intelligence for generating an answer to the question is recorded,
the program causing a computer to execute processing of:
managing semantic rule information including a semantic rule for acquiring, as linkage information, information in the Web page whose semantic linkage is specified on a basis of grammar of a source code of the Web page, and cyclic rule information including a cyclic rule for defining a cyclic order of a plurality of the Web pages at a time of acquisition of the relevant information;
acquiring the cyclic rule from the cyclic rule information;
acquiring the semantic rule from the semantic rule information; and
circulating the plurality of Web pages on a basis of the acquired cyclic rule to acquire the linkage information from each of the circulated Web pages on a basis of the semantic rule as the relevant information.

10. An information processing system that acquires, from a Web page, relevant information related to a question to be input to a generative artificial intelligence for generating an answer to the question,
the information processing system comprising:
a processor; and
a memory,
the processor
managing semantic rule information including a semantic rule for acquiring, as linkage information, information in the Web page whose semantic linkage is specified on a basis of grammar of a source code of the Web page, and cyclic rule information including a cyclic rule for defining a cyclic order of a plurality of the Web pages at a time of acquisition of the relevant information,
acquiring the cyclic rule from the cyclic rule information,
acquiring the semantic rule from the semantic rule information, and
circulating the plurality of Web pages on a basis of the acquired cyclic rule to acquire the linkage information from each of the circulated Web pages on a basis of the semantic rule as the relevant information.
